(19) United States
(12) Patent Application Publication
(10) Pub. No.: US 2023/0316813 A1
(43) Pub. Date: Oct. 5, 2023

(54) SIMULTANEOUS FINGER/FACE DATA COLLECTION TO PROVIDE MULTI-MODAL BIOMETRIC IDENTIFICATION

(71) Applicant: SCIOMETRICS, LLC, Chantilly, VA (US)

(72) Inventor: Mark A. WALCH, Fairfax Station, VA (US)

(21) Appl. No.: 18/130,814

(22) Filed: Apr. 4, 2023

Related U.S. Application Data
(60) Provisional application No. 63/327,329, filed on Apr. 4, 2022.

(51) Int. Cl. G06V 40/50; G06V 40/12; G06V 40/16

(52) U.S. Cl. CPC G06V 40/50; G06V 40/12; G06V 40/16

(57) ABSTRACT

A method comprising using at least one hardware processor to: load a touchless finger/face application onto user system; receive enrollment information through the touchless finger/face application; prompt a user to capture four-finger fingerprint image from a right and/or left; capture the finger prints using a camera included with the user system; simultaneously deploy face detection to sense presence of a user face; once a face is detected, capture face images as a second biometric modality; render the fingerprints into high contrast finger images; and generate a biometric record containing the rendered fingerprints face images.

### CROSS-REFERENCE TO RELATED APPLICATIONS

This application claims priority to U.S. Provisional Patent App. No. 63/327,329, filed on Apr. 4, 2022, entitled “Simultaneous Finger/Face Data Collections to Provide Multi-Modal Biometric Identification”, which is hereby incorporated herein by reference as if set forth in full.

### BACKGROUND

### Field of the Invention

The embodiments described herein are generally directed to multi-modal biometric identification, and more particularly, to the simultaneous face and finger data collection for use in biometric identification.

### Description of the Related Art

Automated fingerprinting and face recognition are the two principal ways for automatic biometric identification. Computer-based face recognition quantifies facial features such as distance between the eyes, depth of eye sockets, distance from forehead to chin, shape of cheekbones, contour of lips and the like. Face recognition is typically achieved through analysis of a photo or video stream of the face. No direct contact between the face and sensor is necessary.

Fingerprints on the other hand are more akin to a barcode and are truly the “human barcode”, which is well suited for unique identification by computers; however, conventional fingerprint sensors require a person to touch the device platen or sensor. Disadvantages to this mode of acquisition include the time required to collect (particularly rolled) prints as well as hygiene concerns. Recently, technologies have been developed to use smartphones as fingerprinting devices. Since capturing fingerprints with the camera on a phone does not require physical contact, this method of collection has been labeled “touchless fingerprinting”.

### SUMMARY

Accordingly, systems, methods, and non-transitory computer-readable media are disclosed to multi-modal biometric identification.

According to one aspect, a method comprising using at least one hardware processor to: load a touchless finger/face application onto user system; receive enrollment information through the touchless finger/face application; prompt a user to capture four-finger fingerprint image from a right and/or left; capture the finger prints using a camera included with the user system; simultaneously deploy face detection to sense presence of a user face; once a face is detected, capture face images as a second biometric modality; render the fingerprints into high contrast finger images; and generate a biometric record containing the rendered fingerprints face images.

According to another aspect, a system comprising: at least one hardware processor; and one or more software modules that are configured to, when executed by the at least one hardware processor, load a touchless finger/face application onto user system; receive enrollment information through the touchless finger/face application; prompt a user to capture four-finger fingerprint image from a right and/or left; capture the finger prints using a camera included with the user system; simultaneously deploy face detection to sense presence of a user face; once a face is detected, capture face images as a second biometric modality; render the fingerprints into high contrast finger images; and generate a biometric record containing the rendered fingerprints face images.

According to another aspect, a non-transitory computer-readable medium having instructions stored therein, wherein the instructions, when executed by a processor, cause the processor to: load a touchless finger/face application onto user system; receive enrollment information through the touchless finger/face application; prompt a user to capture four-finger fingerprint image from a right and/or left; capture the finger prints using a camera included with the user system; simultaneously deploy face detection to sense presence of a user face; once a face is detected, capture face images as a second biometric modality; render the fingerprints into high contrast finger images; and generate a biometric record containing the rendered fingerprints face images.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIGS. 3A-B show two methods for capturing fingerprints, according to an embodiment;

FIG. 4 shows native auto-focus and distance sensors for locating hand position, according to an embodiment;

FIGS. 5A-B present an example method for capturing fingerprints using a smartphone camera, according to an embodiment;

FIG. 6 depicts the simultaneous capture of finger and face images using front and back cameras from the smartphone, according to an embodiment;

FIGS. 7A-C show a touchless fingerprint application via which a user can capture, e.g., a four-finger slap using the fingerprinting application and the smartphone's rear camera, according to an embodiment;

FIG. 8 is a flow chart illustrating a process for using a fingerprinting application to capture both finger prints and a face image for identification purposes, according to an embodiment;

FIG. 9 illustrates use of the systems and methods described herein to capture fingers, face, and an identity document simultaneously, according to an embodiment; and

FIG. 10 illustrates a sample record that can then be created from session depicted in FIG. 8, according to an embodiment.

### DETAILED DESCRIPTION

In an embodiment, systems, methods, and non-transitory computer-readable media are disclosed for multi-modal biometric identification.

Touchless fingerprinting can be performed by the rear smartphone camera with no additional hardware. A 12-megapixel camera can produce high resolution images that capture sufficient friction ridge detail to support fingerprint matching.

A typical strategy for touchless fingerprinting is to capture 10 fingers in three or four pictures: two “slaps” (four fingers each) plus two thumbs (either held together or separated). Once captured, the images are processed into high-contrast prints; features are extracted from these prints and placed into record format suitable for automated inquiries—such as a standard image format (.png, jpg, etc) or as specialized biometric format (EFTS, EBTS). Matching can either be performed on the mobile device or the fingerprint images can be set to a remote server—or cloud location—for matching. In those cases where fingerprint matching is not performed on the device, the fingerprint images are typically sent to an Automated Fingerprint Identification System (AFIS) which is typically operated by a Federal, State or Local Government entity.

Touchless fingerprinting is described in U.S. Pat. No. 9,684,815 entitled “Mobility empowered biometric appliance a tool for real-time verification of identity through fingerprints,” and U.S. patent application Ser. No. 17/377,271, filed Jul. 15, 2021, entitled “Methods to Support Touchless Fingerprinting,” each of which is incorporated herein by reference as if set forth in full. The later application covers improvements to the touchless fingerprinting process to improve throughput and quality of output. Both these specifications provide examples of novel components necessary for creating a touchless fingerprinting device. The ensuing discussion provides methods to improve performance of such a device, e.g., by enabling the concurrent capture of face with fingerprinting.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

### 1.1. Infrastructure

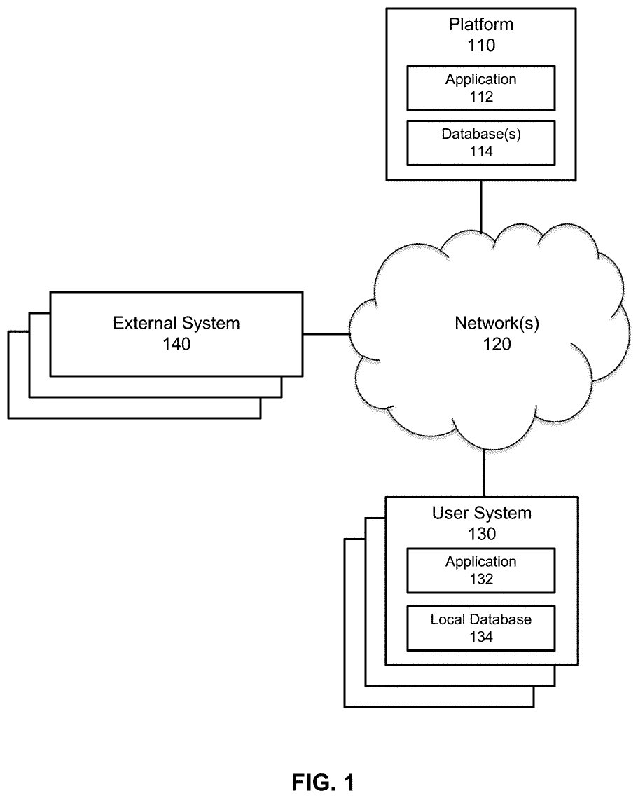

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes, methods, functions, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. It should be understood that platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation My SQL™, Oracle™ IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

### 1.2. Example Processing Device

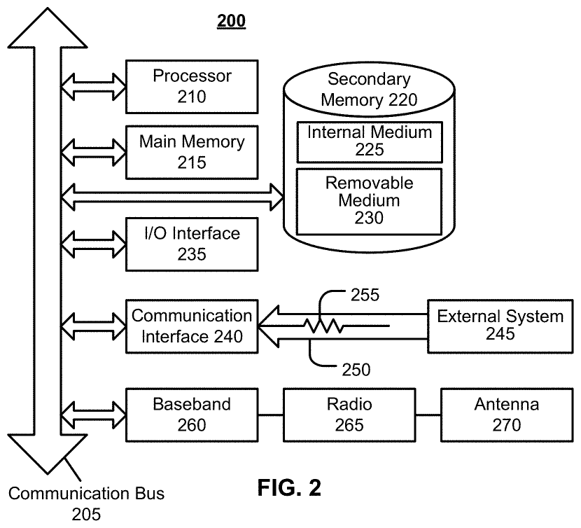

FIG. 2 is a block diagram illustrating an example wired or wireless system 200 that may be used in connection with various embodiments described herein. For example, system 200 may be used as or in conjunction with one or more of the processes, methods, or functions (e.g., to store and/or execute the software) described herein, and may represent components of platform 110, user system(s) 130, external system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 200 may comprise a communication interface 240. Communication interface 240 allows software to be transferred between system 200 and external devices (e.g. printers), networks, or other information sources. For example, computer-executable code and/or data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enable system 200 to perform the various functions of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various functions of the disclosed embodiments.

### 2. Process Overview

Embodiments of processes for multi-modal biometric identification will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

### 2.1. Face Matching

Face matching is currently the mainstay of identity verification in support of transaction processing. While face is the principal way people recognize each other, it is difficult for a computer to perform facial recognition reliably at scale because the number of features presented by the face are relatively few and the character of the features can change given variations in the conditions under which they are observed. Faces are three-dimensional objects and the features they exhibit are very much related to the position from which the face is observed and influenced by many other factors. The variation in features can be quite dramatic and it is not possible to project a profile view from data collected as a full-frontal image. In addition to pose (viewing vantage angle), other issues that affect face are aging, illumination, expression, resolution (distance) and occlusion.

Touchless fingerprinting offers a biometric modality that can be combined with face matching to create two-factor identification.

### 2.2. Touchless Fingerprint

The '271 Application describes a multi-burst focus method for capturing the best picture from a series of photographs. This method also provides independent finger focusing.

Touchless fingerprinting can be performed by the rear smartphone camera with no additional hardware. A 12 megapixel camera can produce high resolution images that capture sufficient friction ridge detail to support fingerprint matching.

A typical strategy for touchless fingerprinting is to capture 10 fingers in three pictures: two “slaps” (four fingers each) plus two thumbs held together. Once captured, the images are processed into high-contrast prints; features are extracted from these prints and placed into record format suitable for automated inquiries—such as a standard image format (.png, jpg, etc) or as specialized biometric format (EFTS, EBTS). Matching can either be performed on the mobile device or the fingerprint images can be set to a remote server—or cloud location—for matching. In those cases where fingerprint matching is not performed on the device, the fingerprint images are typically sent to an Automated Fingerprint Identification System (AFIS) which is typically operated by a Federal, State or Local Government entity.

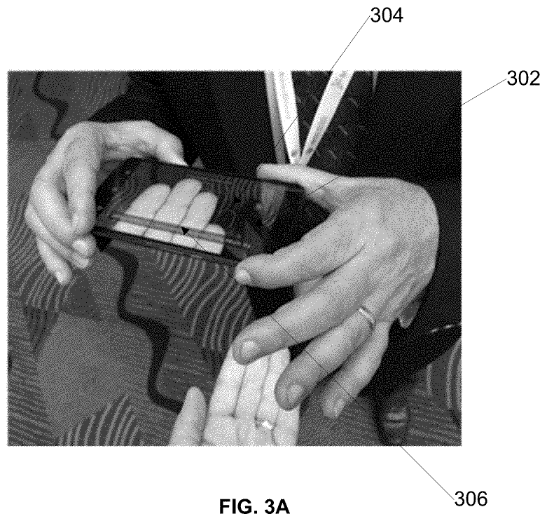

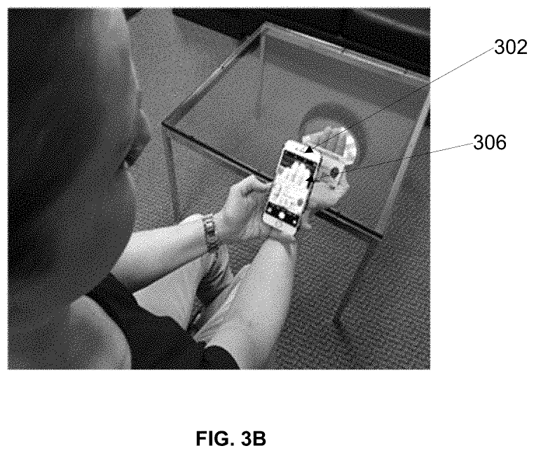

FIGS. 3A-B show two methods for capturing fingerprints: (1) administered and (2) selfie. Administered capture involves one person capturing fingerprints from another person. selfie entails capturing ones' own prints. As can be seen in FIG. 3A, the administrator uses a device 302 with a display 3404 and camera (not shown) to capture an image 306 of the users four fingers. In FIG. 3B, the user uses their own device 302 to capture and image of their fingers 306. The systems and methods described herein primarily use selfie fingerprinting where people capture their own biometrics.

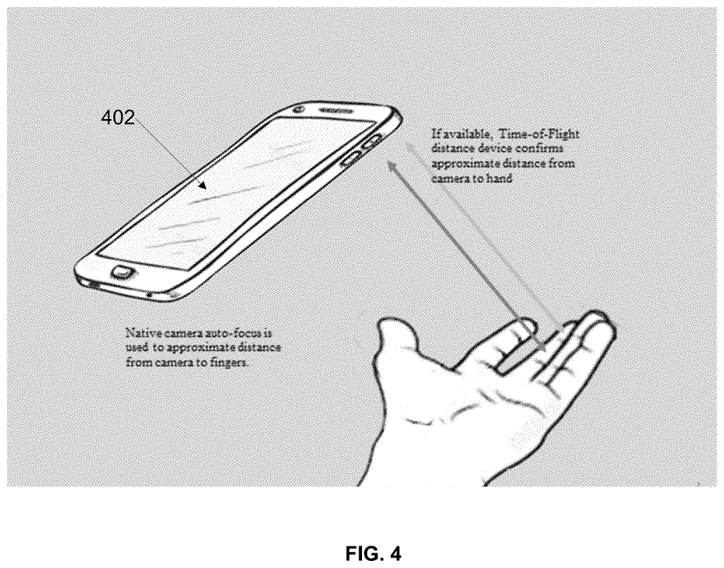

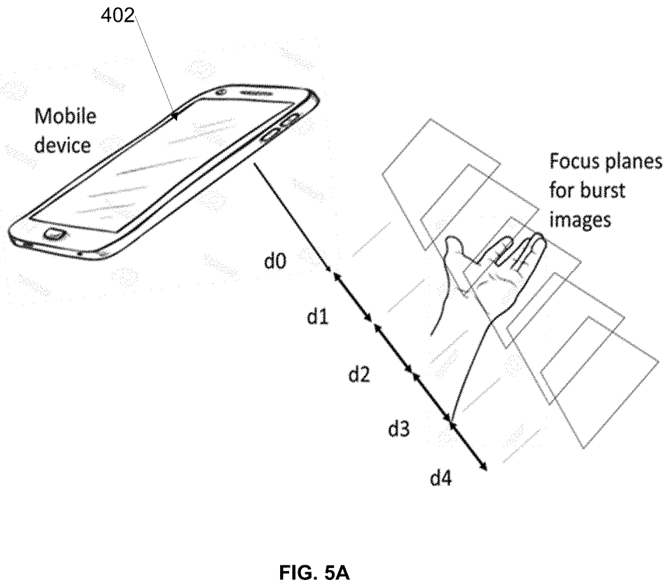

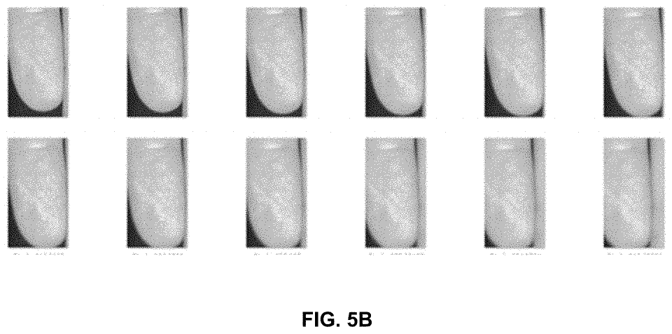

FIGS. 4 and 5A-B present examples of two methods for capturing fingerprints using a smartphone camera 402. These methods are described in the ensuing paragraphs and are herein presented as examples of fingerprint capture methods doable from a standard mobile device 402. They are not presented as the exclusive way to capture fingerprints.

FIG. 4 shows native auto-focus and distance sensors for locating hand position.

The process illustrated in FIGS. 4 and 5A-B leverages a routine to produce an in-focus image for each finger being captured. The results from the routine are dependent on the characteristics and capabilities of the hardware camera and camera control software. FIGS. 5A and B illustrate the process of taking a burst of multiple images at multiple distances from the camera. The bursts start at a point close to the near focus of the lens and extend several inches from this point away from the camera. The purpose of the “burst zone” is to create an area where the hand can be placed to ensure an in-focus picture will be captured.

In FIG. 5A, the dimension d0 represents the distance from the camera (not shown) to the plane of the first image within the burst. Distances d1, d2, d3 and d4 represent additional bursts taken at incremental distances. The actual distance between images is determined by the depth-of-field of the camera at a particular distance. Images are captured at increments equal to the depth of field to ensure there is a zone between the beginning and end of the burst sequence where an in-focus version of the finger can be found. FIG. 5B shows changes in focus as images are captured at different focus planes.

Implementing a mobile fingerprinting capability without operator guidance requires adaptation of the mobile device 302 to capture images likely to contain friction ridge detail. Revealing ridges requires focus and image resolution work hand-in-hand to achieve a sharply focused image with an established resolution. Modern smartphones provide control access to the onboard camera to set focus distance through software, e.g., application 132.

Achieving touchless capture as herein described, requires control of focus and resolution by “image stacking”—that is, through software, the device 302 captures a series of images at slightly different distances, evaluating each photograph and selecting the one that is in best focus. Finding the best image in the image stack is based on evaluating every frame taken in a specified distance interval across a specified time frame.

Thus, the camera can begin a prescribed starting position and moves incrementally to capture a series of images. The increments are also configurable and based upon the depth of field of the camera at a certain f-value and focus distance. Once the images are captured, they can be evaluated for best focus using an algorithm designed expressly for fingerprint ridge structure. The focus in each frame can be determined by taking the average per pixel convolution value of a Laplace filter over a small region of the full resolution image that the target's skin encompasses.

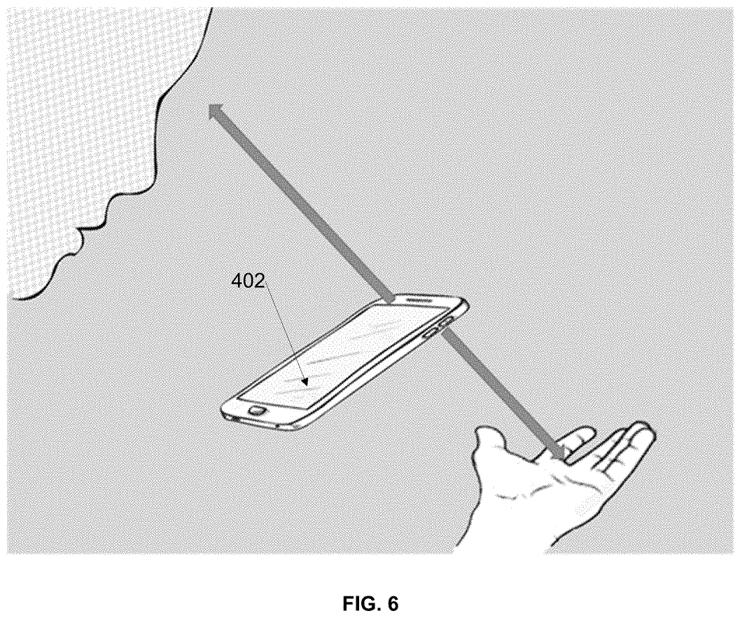

The description of FIG. 6 in the '271 application, which is incorporated herein by reference, describes the Laplace-based method for finger focus detection. First, in step I, an image of a user's fingers is captured. The size of the region comprising the fingers is adjusted based off the current focal distance reported by the camera to reduce the chance that background is included in target region, thus negatively impacting the averaged value. For larger focal distances, the viewed target is smaller in pixel measurements, so the region's size is reduced to better guarantee skin coverage within the entire region. Likewise, smaller focus distances have larger target regions.

Focus can be adjusted in real time or it can be applied as an analysis to a stack of images. In the real time implementation, after each frame's focus value is calculated, the camera's focus distance is adjusted in attempt to better the focus value upon the next frame's capture. The determination of which direction (closer or farther) to adjust the focus is based on the difference of the focus values of the last two frames in the following manner:
1) if the focus is getting worse, then reverse the direction of focus distance adjustment,
2) if the focus is getting better, maintain the direction of focus distance adjustment.

Initially the incremental step that the focus distance is adjusted is large (and can be configurable), but after each focus distance adjustment, the magnitude of the incremental step is slightly reduced. The adjustment of the incremental step continues until the incremental step is reduced to a configurable minimum value.

Since the “ideal” focus distance is constantly changing due to both the unsteady camera and the unsteady target, this method good for quickly adjusting the focus distance to the ballpark of where it should be to have the target in focus, and then minimally adjusted for the remainder of the stream to capture a frame of the moving target at a locally maximized focus value. The steps involved in automated focusing for fingerprints is resented in FIG. 5A.

Thus, the Laplace based method comprises, in step I, an image is captured at an initial focus distance. Then in step II, the captured image is convolved with Laplacian of Gaussian kernel. In step III, scores are assigned to a filtered image reflecting the amount to fine edge resolution. In step IV, the focus is then dynamically updated until an optimal distance is found.

Once focus distance is established, it becomes the basis for calculating image resolution. The resolution of the best, full resolution image is derived from the focus distance, FD, recorded at the time the image was taken. The resolution of the image is equal to (W*FL)/(Sx*FD) where W is the width of the camera image, FL is the focus length of the camera and Sx is the physical sensor size, e.g., the width in this case, of the camera.

In the absence of the ability to control focus distance, the conventional solution has been to place an object of known dimension in the image. Such “target” based techniques can be used with older equipment where camera controls are not provided.

If focus evaluation is applied as a post image capture step, the same process is applied sequentially to each frame resulting in a frame-specific score. Once scores for all the images have been captured, the scoring can be compared to find the image with the best finger focus. The ability to capture multiple images permits a best focus to be established for individual fingers.

The rear camera of most smartphones 402 is equipped with a general auto-focus capability to promote picture quality. Since this focus capability is designed to focus all conceivable situations, it is less-than-optimal for focusing on fingerprint friction ridges which are finely detailed and subtly colored. Also, many modern phones provide some form of “distance camera” in the form of a time-of-flight (ToF) sensor or LIDAR.

Both the native auto-focus and distance cameras can be used to obtain fingerprints, but these methods alone fall short of fulfilling what is possible from modern mobile devices. The auto-focus method uses the native camera focusing capability coupled with the measurement capabilities of a distance camera (if available) as a first pass to “approximate” the distance between the camera and the finger. By using the smartphone's native capabilities to get the fingers in the focus “zone” this method saves valuable time and streamlines the overall fingerprinting process.

Since the distances between the camera and fingers will always be variable, the method described in FIGS. 5A-B creates a focus zone from 4.5 inches to 9 inches from the camera (on a standard smartphone). Any finger in this zone will be in focus with measured resolution. FIG. 5B illustrates the concept of taking a burst of multiple images at multiple distances (Z-stacking) from the camera. The bursts start at a point close to the near focus of the lens and extend several inches from this point away from the camera. Bursts are separated by a distance equivalent to the depth-of-field of the camera's lens, e.g., based of focal length, distance, and f-stop. The purpose of the “burst zone” is to create an area where the hand can be placed to ensure an in-focus picture will be captured. As the capture burst is being taken, each frame is evaluated for focus using a Laplace-based method—essentially, an auto-focus designed for fingers. The frames with the best focus are retained for further processing.

In the embodiments described herein, the finger focus methods described—or similar methods—can be used with the concurrent capture of the user's face as the fingers are captured.

Many modern smartphones are fitted with two cameras typically referenced as “front camera” and “rear camera”. The front camera is mounted to face the user during operation and is typically utilized for capturing “selfie” photos. The rear camera faces away from the user and is typically used for general photography. In most smartphones, the rear camera has much higher resolution than the front camera. Since finger ridges measure only a few millimeters in width, they typically require the higher resolution of the rear camera to be captured, whereas face resolution does not have the same demanding resolution requirements as fingerprinting and most face technologies are designed to operate on images from the front camera.

### 2.3 Face Matching while Fingerprint

The system and methods described herein provide simultaneous dual modality (finger and face) to support identification of individuals through the two cameras provided by a mobile device 402. This capability is depicted in FIG. 6, which depicts the simultaneous capture of finger and face images using front and back cameras from the smartphone 402.

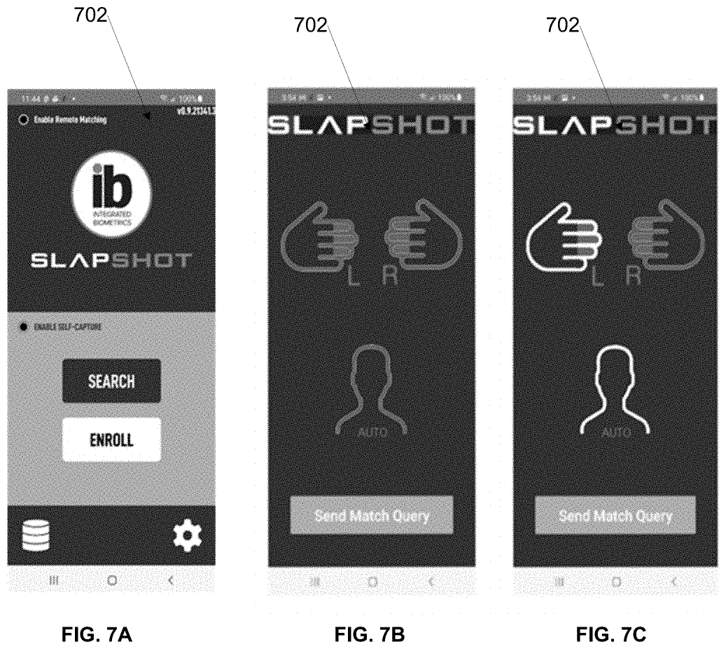

FIGS. 7A-C shows a touchless fingerprint app 702 via which a user can capture, e.g., a four-finger slap using the fingerprinting app 702 and the smartphone's rear camera.

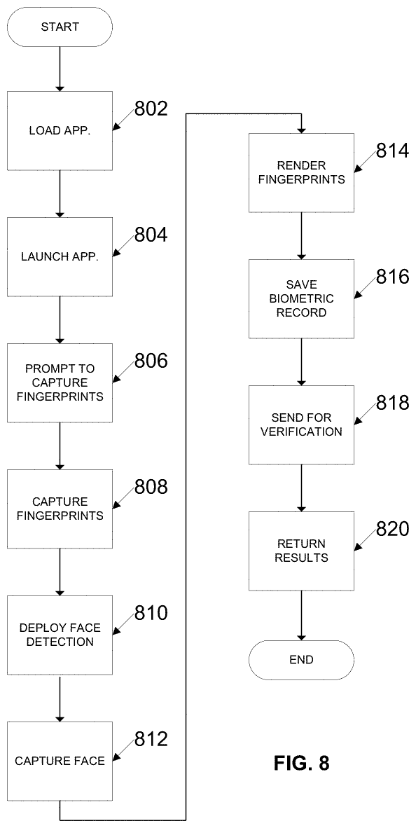

FIG. 8 is a flow chart illustrating a process for using fingerprinting app. 702 to capture both finger prints and a face image for identification purposes. As illustrated in step 802 a user loads touchless finger/face app 702 onto smartphone 402. Once downloaded, the user can launch the application, in step 804, as illustrate din FIG. 7A, where the user can enroll. At which point the user can be prompted, in step 806, to capture four-finger slap from right and/or left hand as illustrated in FIG. 7B. The user can then capture their finger prints, as illustrated in FIGS. 3B and 7C, in step 808. Concurrently, the front camera deploys face detection to sense presence of user face, in step 810. Once face is detected it is also captured as a second biometric modality, in step 812.

In step 814, the fingerprints are rendered into high contrast images as per methods described in the '815 patent.

In step 816, the high contrast finger images and face images are rendered into a standard biometric transfer format such as EBTS and saved as a biometric record. In step 818, the biometric record can be sent to AFIS for matching or verification. In step 820, the results can either be returned to mobile device 402 or another designated receiver.

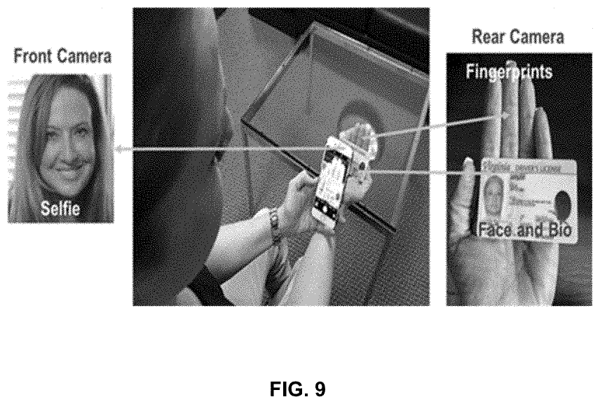

FIG. 9 illustrates use of the systems and methods described herein to capture fingers, face, and an identity document simultaneously.

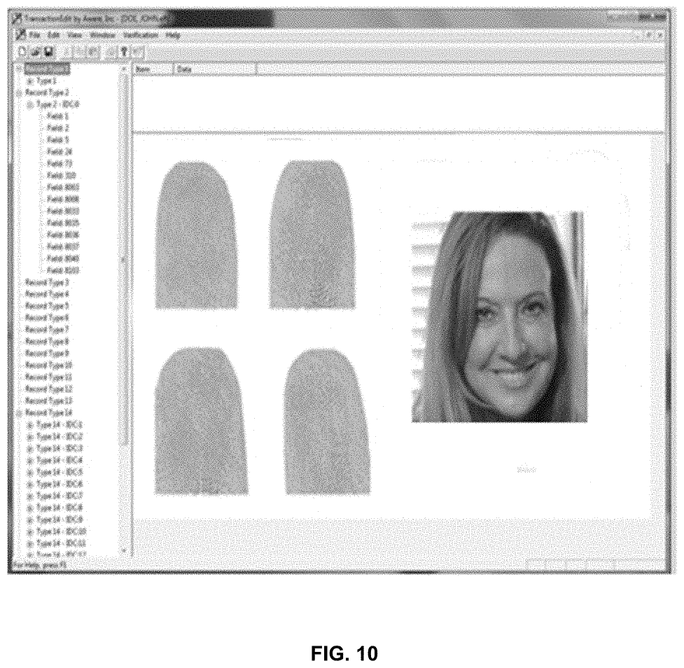

FIG. 10 illustrates a sample record that can then be created from session depicted in FIG. 8.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
load a touchless finger/face application onto user system;
receive enrollment information through the touchless finger/face application;
prompt a user to capture four-finger fingerprint image from a right and/or left;
capture the finger prints using a camera included with the user system;
simultaneously deploy face detection to sense presence of a user face;
once a face is detected, capture face images as a second biometric modality;
render the fingerprints into high contrast finger images; and
generate a biometric record containing the rendered fingerprints face images.

2. The method of claim 1, further comprising rendering the high contrast finger images and face images into a standard biometric transfer format such as EBTS, before generating the biometric record.

3. The method of claim 1, further comprising sending the biometric record to AFIS for matching or verification.

4. The method of claim 1, further comprising returning results to a user system.

5. A system comprising:
at least one hardware processor; and
one or more software modules that are configured to, when executed by the at least one hardware processor,
load a touchless finger/face application onto user system;
receive enrollment information through the touchless finger/face application;
prompt a user to capture four-finger fingerprint image from a right and/or left;
capture the finger prints using a camera included with the user system;
simultaneously deploy face detection to sense presence of a user face;
once a face is detected, capture face images as a second biometric modality;
render the fingerprints into high contrast finger images; and
generate a biometric record containing the rendered fingerprints face images.

6. The system of claim 5, further comprising rendering the high contrast finger images and face images into a standard biometric transfer format such as EBTS, before generating the biometric record.

7. The system of claim 5, further comprising sending the biometric record to AFIS for matching or verification.

8. The system of claim 5, further comprising returning results to a user system.

9. A non-transitory computer-readable medium having instructions stored therein, wherein the instructions, when executed by a processor, cause the processor to:
load a touchless finger/face application onto user system;
receive enrollment information through the touchless finger/face application;
prompt a user to capture four-finger fingerprint image from a right and/or left;
capture the finger prints using a camera included with the user system;
simultaneously deploy face detection to sense presence of a user face;
once a face is detected, capture face images as a second biometric modality;
render the fingerprints into high contrast finger images; and
generate a biometric record containing the rendered fingerprints face images.

10. The method of claim 9, further comprising rendering the high contrast finger images and face images into a standard biometric transfer format such as EBTS, before generating the biometric record.

11. The method of claim 9, further comprising sending the biometric record to AFIS for matching or verification.

12. The method of claim 9, further comprising returning results to a user system.
